(19) United States
(12) Patent Application Publication
(10) Pub. No.: US 2026/0084419 A1
(43) Pub. Date: Mar. 26, 2026

(54) LIQUID DISCHARGE APPARATUS AND PRINT HEAD

(71) Applicant: SEIKO EPSON CORPORATION, Tokyo (JP)

(72) Inventors: Kazunori HIRAMATSU, Okaya (JP); Sukehiro ITO, Matsumoto (JP)

(21) Appl. No.: 19/336,582

(22) Filed: Sep. 23, 2025

(30) Foreign Application Priority Data
Sep. 25, 2024 (JP) 2024-166298

(51) Int. Cl. B41J 2/045

(52) U.S. Cl. CPC B41J 2/0455; B41J 2/04541; B41J 2/04548; B41J 2/04581; B41J 2/04588

(57) ABSTRACT

A liquid discharge apparatus includes a head unit, a carriage on which the head unit is mounted, a control unit including a drive circuit that generates a drive signal, and a drive signal supply line, in which the head unit includes a print head provided with a discharge section that discharges liquid, and a drive controller that controls the application of the drive signal to the discharge section, and a drive signal correction circuit electrically coupled to the drive signal supply line, and the drive signal correction circuit steps up the drive signal and supplies the drive signal to the drive controller when a voltage of the drive signal supplied from the control unit via the drive signal supply line is lower than a voltage of a reference waveform signal by a first voltage or more.

The present application is based on, and claims priority from JP Application Serial Number 2024-166298, filed Sep. 25, 2024, the disclosure of which is hereby incorporated by reference herein in its entirety.

### BACKGROUND

### 1. Technical Field

The present disclosure relates to a liquid discharge apparatus and a print head.

### 2. Related Art

In a large printer such as a large format printer, the transmission path of drive signals generated by a main substrate to a print head is long, and it is widely recognized that the drive waveform is distorted due to the effect of the longer transmission path. In response to such issues, various proposals are made in JP-A-2018-202713 and JP-A-2017-170768 from the viewpoint of preventing damage to a circuit due to the supply of an overvoltage to the print head.

However, with the above proposals, it is possible to reduce the distortion of the drive waveform that results in the supply of an overvoltage to the print head, but it is not possible to address other types of distortion of the drive waveform. In view of this situation, the inventors of the present application have discovered a new method for reducing distortions other than the distortion of the drive waveform that results in the supply of an overvoltage to the print head.

### SUMMARY

According to an aspect of the present disclosure, a liquid discharge apparatus includes a head unit, a carriage on which the head unit is mounted, a control unit including a drive circuit that generates a drive signal, and a drive signal supply line that supplies the drive signal from the control unit to the head unit, in which the head unit includes a print head provided with a discharge section that discharges liquid when the drive signal is applied, and a drive controller that controls the application of the drive signal to the discharge section, and a drive signal correction circuit electrically coupled to the drive signal supply line, and the drive signal correction circuit steps up the drive signal and supplies the drive signal to the drive controller when a voltage of the drive signal supplied from the control unit via the drive signal supply line is lower than a voltage of a reference waveform signal by a first voltage or more.

According to an aspect of the present disclosure, a print head includes a discharge section that discharges liquid when a drive signal is applied, a drive controller that controls the application of the drive signal to the discharge section, and a drive signal correction circuit, in which the drive signal is supplied to the drive signal correction circuit via a drive signal supply line outside the print head, and the drive signal correction circuit steps up the drive signal and supplies the drive signal to the drive controller when a voltage of the drive signal is lower than a voltage of a reference waveform signal by a first voltage or more.

### BRIEF DESCRIPTION OF THE DRAWINGS

FIG. 1 is a diagram showing a schematic structure of a liquid discharge apparatus.

FIG. 2 is a diagram showing a functional configuration of the liquid discharge apparatus according to a first embodiment.

FIG. 3 is a diagram for illustrating a schematic configuration of a discharge section.

FIG. 4 is a diagram showing an example of a signal waveform of a drive signal.

FIG. 5 is a diagram showing an example of a relationship between a size of a dot formed on a medium and a signal waveform of a drive voltage.

FIG. 6 is a diagram showing an example of a functional configuration of a drive signal selection circuit.

FIG. 7 is a diagram showing an example of decoding contents of a decoder included in a selection control circuit.

FIG. 8 is a diagram showing an example of a configuration of a selection circuit corresponding to the discharge section.

FIG. 9 is a diagram for illustrating a specific example of a latch signal, a change signal, a clock signal, and a print data signal.

FIG. 10 is a diagram showing a configuration of a drive signal correction circuit.

FIG. 11 is a diagram showing a part of waveforms of a drive signal via a drive signal supply line and a reference waveform signal via a reference waveform signal supply line.

FIG. 12 is a diagram showing a measurement example of a drive signal and a reference waveform signal in a comparative example.

FIG. 13 is a diagram showing a measurement example of a drive signal and a reference waveform signal in the present embodiment.

FIG. 14 is a diagram showing a functional configuration of a liquid discharge apparatus according to a second embodiment.

### DESCRIPTION OF EMBODIMENTS

Hereinafter, preferred embodiments of the present disclosure will be described with reference to the drawings. The drawings to be used are for convenience of description. In addition, embodiments to be described below do not inappropriately limit the contents of the present disclosure described in the claims. Moreover, not all of configurations to be described below are necessarily essential requirements of the present disclosure.

In the following description, an ink jet printer is exemplified as an example of a liquid discharge apparatus according to the present disclosure.

### 1. First Embodiment

### 1-1. Overview of Liquid Discharge Apparatus

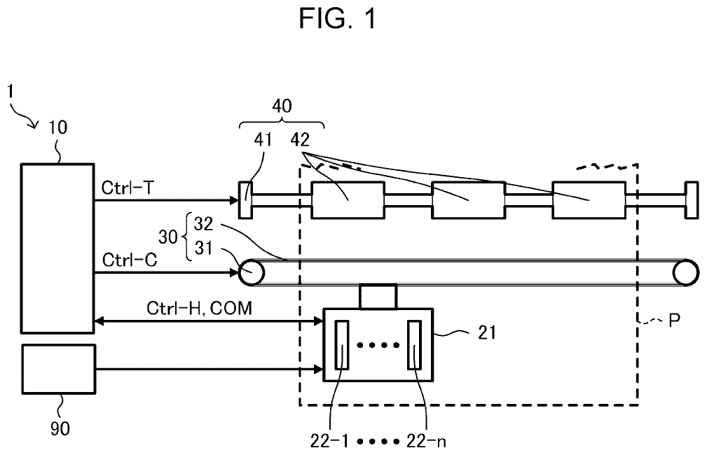

FIG. 1 is a diagram showing an example of a schematic configuration of a liquid discharge apparatus 1. The liquid discharge apparatus 1 of the present embodiment is a so-called serial printing type ink jet printer in which a carriage 21 on which print heads 22-1 to 22-n are mounted reciprocates along a scanning axis, and the print heads 22-1 to 22-n discharge ink, as an example of liquid, onto a medium P transported along a transport direction, thereby forming a desired image on the medium P. As the medium P used in the liquid discharge apparatus 1, in addition to printing paper such as plain paper, any printing medium such as a resin film or a fabric can be used.

As shown in FIG. 1, the liquid discharge apparatus 1 includes a control unit 10, print heads 22-1 to 22-n, a movement unit 30, a transport unit 40, and an ink container 90.

A plurality of types of ink to be discharged to the medium P are stored in the ink container 90. An ink cartridge, a bag-shaped ink pack formed of a flexible film, an ink tank that can be replenished with ink, or the like can be used as the ink container 90.

The control unit 10 includes a processing circuit such as a Central Processing Unit (CPU) or a field programmable gate array (FPGA) and a storage circuit such as a semiconductor memory, and controls each element of the liquid discharge apparatus 1.

The print heads 22-1 to 22-n are mounted on the carriage 21. A control signal Ctrl-H and a drive signal COM output by the control unit 10 are input to the print heads 22-1 to 22-n. In addition, the ink stored in the ink container 90 is supplied to the print heads 22-1 to 22-n via a tube (not shown) or the like. Each of the print heads 22-1 to 22-n discharges the supplied ink onto the medium P based on the control signal Ctrl-H and the drive signal COM.

The movement unit 30 includes a carriage motor 31 and an endless belt 32. The carriage motor 31 is operated based on a control signal Ctrl-C input from the control unit 10. The carriage 21 on which the print heads 22-1 to 22-n are mounted is fixed to the endless belt 32. In addition, the endless belt 32 rotates in accordance with the operation of the carriage motor 31. Then, the carriage 21 fixed to the endless belt 32 moves along the scanning direction by the rotation of the endless belt 32. That is, the movement unit 30 controls the movement of the print heads 22-1 to 22-n mounted on the carriage 21.

The transport unit 40 includes a transport motor 41 and transport rollers 42. The transport motor 41 operates based on a control signal Ctrl-T input from the control unit 10. The transport rollers 42 rotate according to an operation of the transport motor 41 in a state where the medium P is pinched therebetween. The medium P pinched between a pair of transport rollers 42 is transported along the transport direction by the rotation of the transport rollers 42. That is, the transport unit 40 controls the transport of the medium P.

In the liquid discharge apparatus 1 configured as described above, the movement unit 30 controls the reciprocating motion of the carriage 21 along the scanning direction, and the transport unit 40 controls the transport of the medium P along the transport direction. Then, each of the print heads 22-1 to 22-n mounted on the carriage 21 discharges ink to the medium P in conjunction with the reciprocating motion of the carriage 21 and the transport of the medium P. As a result, the ink discharged from each of the print heads 22-1 to 22-n lands on any surface of the medium P, and a desired image is formed on the medium P.

### 1-2. Functional Configuration of Liquid Discharge Apparatus

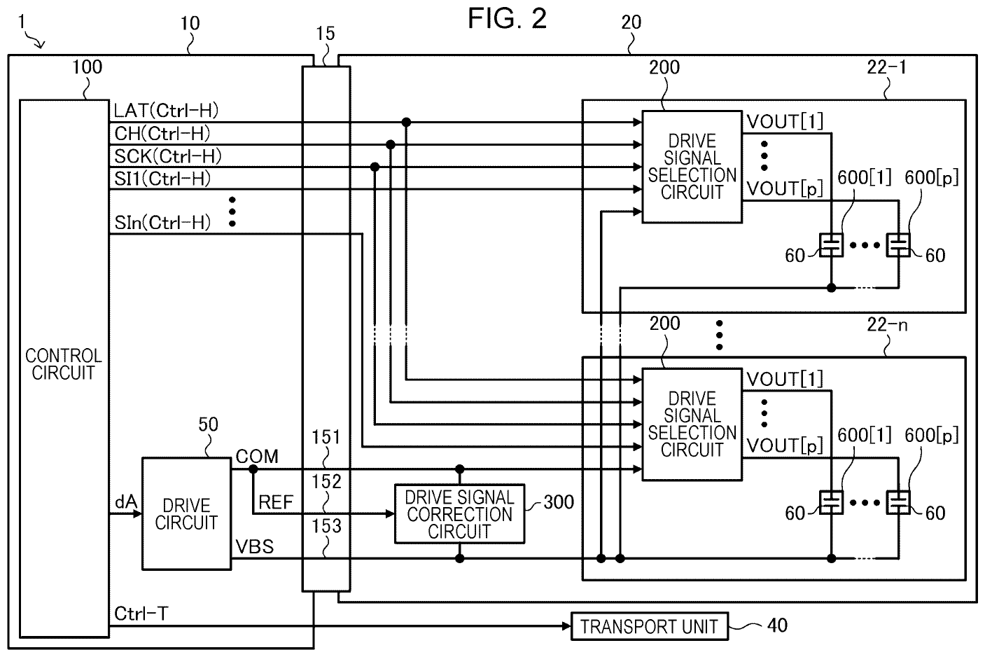

Next, a functional configuration of the liquid discharge apparatus 1 will be described. FIG. 2 is a diagram showing the functional configuration of the liquid discharge apparatus 1. As shown in FIG. 1, the liquid discharge apparatus 1 includes a control unit 10, a head unit 20, and a transport unit 40.

The control unit 10 and the head unit 20 are coupled to each other by a cable 15. The cable 15 is a sliding cable that can follow the movement of the carriage 21, and may be, for example, a flexible flat cable (FFC).

The control unit 10 includes a drive circuit 50 and a control circuit 100.

The control circuit 100 includes, for example, a processor such as a microcontroller, and is communicably coupled to an external device such as a host computer (not shown) provided outside the liquid discharge apparatus 1. An image information signal including image data formed on the medium P from the external device is input to the control circuit 100. The control circuit 100 performs predetermined image processing on the input image information signal to generate various kinds of data for controlling the liquid discharge apparatus 1 and a signal according to the data, and outputs the data and the signal to the corresponding configuration.

The control circuit 100 generates a control signal Ctrl-T for controlling the transport of the medium P, and outputs the control signal Ctrl-T to the transport unit 40. As a result, the transport motor 41 included in the transport unit 40 is rotationally driven, and the transport in the transport direction of the medium P is controlled. Here, the control signal Ctrl-T output by the control circuit 100 may be input to the transport motor 41 after being signal-converted in a driver circuit (not shown).

In addition, the control circuit 100 generates a latch signal LAT, a change signal CH, a clock signal SCK, and print data signals SI1 to SIn as the control signal Ctrl-H for controlling the head unit 20 based on the input image information signal, and outputs the latch signal LAT, the change signal CH, the clock signal SCK, and the print data signals SI1 to SIn to the head unit 20 via the cable 15. The details of the latch signal LAT, the change signal CH, the clock signal SCK, and the print data signals SI1 to SIn will be described later.

Further, the control circuit 100 outputs a reference drive signal dA, which is a digital signal, to the drive circuit 50. The drive circuit 50 generates a drive signal COM including one or a plurality of signal waveforms by performing digital/analog signal conversion on the reference drive signal dA of the input digital signal and then performing class D amplification on the converted analog signal. The drive circuit 50 may generate a plurality of drive signals COM. The drive circuit 50 outputs the generated drive signal COM to the head unit 20 via a drive signal supply line 151 of the cable 15. Here, the reference drive signal dA is a digital signal for defining the signal waveform of the drive signal COM, and the drive circuit 50 generates the drive signal COM by performing class D amplification on the signal waveform defined by the reference drive signal dA. Therefore, the reference drive signal dA may be an analog signal as long as the signal waveform of the drive signal COM can be defined. In addition, the drive circuit 50 may amplify the signal waveform defined by the reference drive signal dA and output the amplified signal waveform as the drive signal COM. Therefore, the drive circuit 50 may generate the drive signal COM by performing class A amplification, class B amplification, or class AB amplification on the signal waveform defined by the reference drive signal dA.

In addition, the drive circuit 50 generates a reference voltage signal VBS that is a reference potential for driving a piezoelectric element 60 described later included in the head unit 20. The drive circuit 50 outputs the generated reference voltage signal VBS to the head unit 20 via the reference voltage signal supply line 153 of the cable 15. The reference voltage signal VBS is a signal having a constant voltage value, for example, a signal having a voltage value of 0 V at the ground potential, or a DC voltage signal having a voltage value of 5.5 V, 6 V, or the like.

The head unit 20 includes print heads 22-1 to 22-n and a drive signal correction circuit 300. Further, the print head 22-i includes a drive signal selection circuit 200 and p discharge sections 600[1] to 600[p]. i is each integer of 1 or more and n or less.

The drive signal selection circuit 200 includes one or a plurality of integrated circuit devices. The latch signal LAT, the change signal CH, the clock signal SCK, a print data signal SIi, and the drive signal COM are input to the drive signal selection circuit 200. The drive signal selection circuit 200 generates and outputs the drive voltages VOUT[1] to VOUT[p] that individually correspond to each of the discharge sections 600[1] to 600[p] by selecting or deselecting the signal waveforms of the drive signal COM based on the input latch signal LAT, the change signal CH, the clock signal SCK, and the print data signal SIi. That is, the drive signal selection circuit 200 functions as a drive controller that controls the application of the drive signal COM to the discharge sections 600[1] to 600[p]. The details of the configuration and operation of the drive signal selection circuit 200 will be described later.

Each of the discharge sections 600[1] to 600[p] includes the piezoelectric element 60. The drive voltage VOUT[j] output by the drive signal selection circuit 200 is supplied to one end of the piezoelectric element 60 included in the discharge section 600[j]. j is each integer of 1 or more and p or less. In addition, the reference voltage signal VBS is commonly supplied to the other ends of the p piezoelectric elements 60 included in the discharge sections 600[1] to 600[p]. The piezoelectric element 60 included in the discharge section 600[j] is displaced by a potential difference between the drive voltage VOUT[j] and the reference voltage signal VBS. The ink having an amount corresponding to the displacement of the piezoelectric element 60 is discharged from the corresponding discharge section 600[j]. Since the drive voltage VOUT[j] is generated by selecting or deselecting the signal waveform of the drive signal COM, in other words, the discharge section 600[j] discharges ink when the drive signal COM is applied. Then, the ink discharged from the discharge sections 600[1] to 600[p] included in each of the print heads 22-1 to 22-n lands on the medium P, and thus an image is formed on the medium P.

As described above, the discharge section 600[j] included in the print head 22-i applies the drive voltage VOUT[j] generated based on the latch signal LAT, the change signal CH, the clock signal SCK, and the print data signal SIi, to discharge the ink to the medium P. In other words, the latch signal LAT, the change signal CH, the clock signal SCK, and the print data signals SI1 to SIn are the discharge control signals that control the discharge of the ink to the medium P of the discharge section 600[j], respectively, and the discharge section 600[j] discharges the ink to the medium P based on the discharge control signals.

Here, the print heads 22-1 to 22-n all have the same configuration, and may be referred to as a print head 22 when it is not necessary to distinguish the print heads. At this time, it will be described that the print data signal SI is input to the print head 22 as the print data signals SI1 to SIn. In addition, the discharge sections 600[1] to 600[p] included in the print head 22 all have the same configuration, and may be simply referred to as the discharge section 600 when it is not necessary to distinguish the discharge sections. At this time, the description will be made on the assumption that the drive voltage VOUT is supplied to the discharge section 600 as the drive voltages VOUT[1] to VOUT[p].

As described above, the drive circuit 50 outputs the drive signal COM to the head unit 20 via the drive signal supply line 151 of the cable 15, but the drive signal COM simultaneously drives the large number of piezoelectric elements 60, and thus a large current flows through the drive signal supply line 151. Therefore, the waveform of the drive signal COM via the drive signal supply line 151 is distorted by the inductance component of the cable 15. For example, when the liquid discharge apparatus 1 is a large format printer, the distance between the control unit 10 and the head unit 20 is long, and the cable 15 is 2 m or more. Therefore, the inductance component of the cable 15 becomes very large, and a large distortion occurs in the waveform of the drive signal COM. Since the distortion of the waveform of the drive signal COM is a factor that deteriorates the accuracy of the image formed on the medium P, a countermeasure is required.

When the distortion of the drive waveform is always constant, it may be possible to take measures such as generating the drive signal COM considering the waveform distortion in the drive circuit 50 in advance. However, since the cable 15 moves while being largely deformed with the movement of the head unit 20, the distortion of the drive signal COM changes momentarily and the influence of various noises being superimposed on the drive signal COM is also present, and thus such a countermeasure cannot be taken. Therefore, in the present embodiment, the head unit 20 is provided with the drive signal correction circuit 300 that corrects the drive signal COM to reduce the distortion of the waveform of the drive signal COM that changes momentarily.

The drive signal correction circuit 300 is electrically coupled to the drive signal supply line 151 of the cable 15. As described above, the drive signal supply line 151 supplies the drive signal COM from the drive circuit 50 of the control unit 10 to the head unit 20. That is, the drive signal correction circuit 300 is supplied with the drive signal COM from the drive circuit 50 of the control unit 10 via the drive signal supply line 151. In addition, the drive signal correction circuit 300 is electrically coupled to a reference waveform signal supply line 152. The reference waveform signal supply line 152 supplies the drive signal COM before being supplied to the drive signal supply line 151 from the drive circuit 50 of the control unit 10 to the drive signal correction circuit 300 as a reference waveform signal REF. Since the reference waveform signal supply line 152 is not electrically coupled to each piezoelectric element 60, a large current does not flow through the reference waveform signal supply line 152. Therefore, the waveform of the reference waveform signal REF supplied to the drive signal correction circuit 300 via the reference waveform signal supply line 152 is hardly distorted and is substantially the same as the waveform of the drive signal COM generated by the drive circuit 50. In addition, the drive signal correction circuit 300 is electrically coupled to a reference voltage signal supply line 153 of the cable 15. As described above, the reference voltage signal supply line 153 supplies the reference voltage signal VBS from the drive circuit 50 of the control unit 10 to the head unit 20.

The drive signal correction circuit 300 corrects the waveform of the drive signal COM to be close to the waveform of the reference waveform signal REF, and supplies the corrected drive signal COM to the drive signal selection circuit 200. The details of the configuration and operation of the drive signal correction circuit 300 will be described later.

### 1-3. Structure of Discharge Section

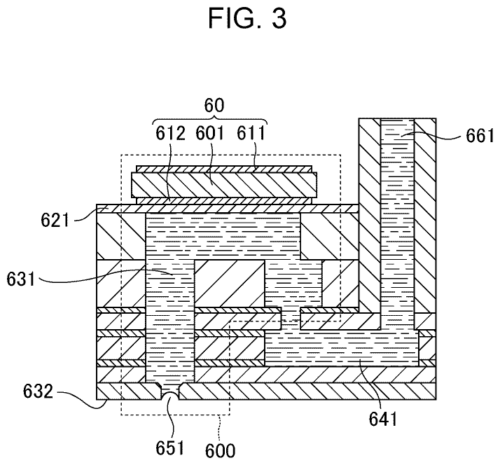

Next, the structure of the discharge section 600 will be described. FIG. 3 is a diagram for illustrating a schematic configuration of the discharge section 600. In addition to the discharge section 600, FIG. 3 illustrates a nozzle plate 632, a reservoir 641, and a supply port 661.

As shown in FIG. 3, the discharge section 600 includes the piezoelectric element 60, a vibrating plate 621, a cavity 631, and a nozzle 651. In addition, the piezoelectric element 60 includes a piezoelectric body 601 and electrodes 611 and 612. The piezoelectric element 60 is configured such that the electrodes 611 and 612 are positioned to interpose the piezoelectric body 601. The piezoelectric element 60 is driven such that the center part is displaced in the up-down direction according to the potential difference between the voltage supplied to the electrode 611 and the voltage supplied to the electrode 612. Specifically, the drive voltage VOUT based on the drive signal COM is supplied to the electrode 611, and the reference voltage signal VBS is supplied to the electrode 612. When the voltage value of the drive voltage VOUT supplied to the electrode 611 changes, the potential difference between the drive voltage VOUT supplied to the electrode 611 and the reference voltage signal VBS supplied to the electrode 612 changes. As a result, the piezoelectric element 60 is driven such that the center part is displaced in the up-down direction.

The vibrating plate 621 is positioned below the piezoelectric element 60 in FIG. 3. In other words, the piezoelectric element 60 is formed on the upper surface of the vibrating plate 621 in FIG. 3. The vibrating plate 621 is displaced in the up-down direction as the piezoelectric element 60 is driven in the up-down direction.

The cavity 631 is positioned below the vibrating plate 621 in FIG. 3. Ink is supplied to the cavity 631 from the reservoir 641. In addition, the ink stored in the ink container 90 is introduced into the reservoir 641 via the supply port 661. That is, the inside of the cavity 631 is filled with the ink stored in the ink container 90. An internal volume of the cavity 631 expands or contracts as the vibrating plate 621 is displaced in the up-down direction. That is, the vibrating plate 621 functions as a diaphragm that changes the internal volume of the cavity 631, and the cavity 631 functions as a pressure chamber of which the pressure changes as the vibrating plate 621 is displaced in the up-down direction.

The nozzle 651 is an opening portion which is provided on the nozzle plate 632 and communicates with the cavity 631. When the internal volume of the cavity 631 changes, the ink filled the inside of the cavity 631 is discharged from the nozzle 651 according to the change in the internal volume.

In the discharge section 600 configured as described above, when the piezoelectric element 60 is driven to bend in the upward direction, the vibrating plate 621 is displaced in the upward direction. As a result, the internal volume of the cavity 631 expands, and as a result, the ink stored in the reservoir 641 is drawn into the cavity 631. On the other hand, when the piezoelectric element 60 is driven to bend in the downward direction, the vibrating plate 621 is displaced in the downward direction. As a result, the internal volume of the cavity 631 contracts, and as a result, the ink having an amount corresponding to the degree of contraction of the internal volume of the cavity 631 is discharged from the nozzle 651.

The piezoelectric element 60 is not limited to the structure shown in FIG. 3 as long as the piezoelectric element 60 is driven by being supplied with the drive voltage VOUT corresponding to the drive signal COM and can discharge ink from the nozzle 651 when driven.

### 1-4. Functional Configuration of Drive Signal Selection Circuit

Next, the configuration and operation of the drive signal selection circuit 200 will be described. In describing the configuration and operation of the drive signal selection circuit 200, an example of a signal waveform of the drive signal COM input to the drive signal selection circuit 200 and an example of a signal waveform of the drive voltage VOUT output from the drive signal selection circuit 200 will be described.

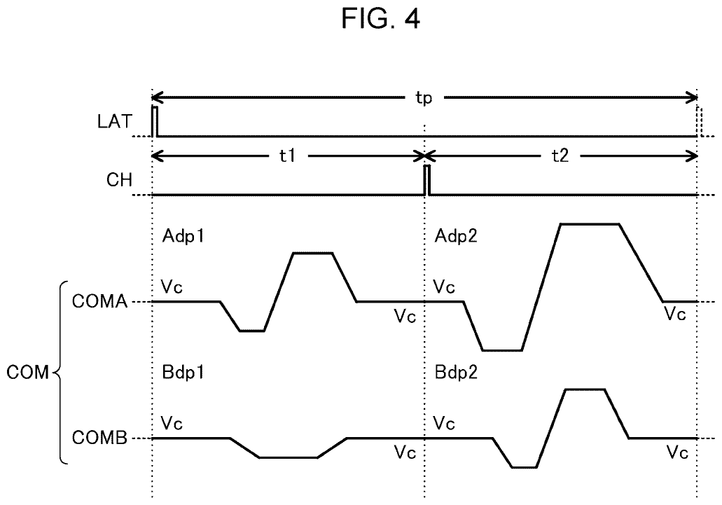

FIG. 4 is a diagram illustrating an example of the signal waveform of the drive signal COM. In FIG. 4, a drive signal COMA and a drive signal COMB are exemplified as the two drive signals COM.

The drive signal COMA has a signal waveform in which a trapezoidal waveform Adp1 arranged in a period t1 from the rise of the latch signal LAT to the rise of the change signal CH, and a trapezoidal waveform Adp2 arranged in a period t2 from the rise of the change signal CH to the rise of the latch signal LAT are continuous to each other. Further, the trapezoidal waveform Adp1 is a signal waveform for discharging a predetermined amount of ink from the discharge section 600 when supplied to the piezoelectric element 60 included in the discharge section 600, and the trapezoidal waveform Adp2 is a signal waveform for discharging an amount of ink larger than a predetermined amount from the discharge section 600 when supplied to the piezoelectric element 60 included in the discharge section 600. Here, in the following description, when the trapezoidal waveform Adp1 is supplied to the piezoelectric element 60 included in the discharge section 600, the amount of ink discharged from the discharge section 600 is referred to as a small amount, and when the trapezoidal waveform Adp2 is supplied to the piezoelectric element 60 included in the discharge section 600, the amount of ink discharged from the discharge section 600 is referred to as a medium amount.

As illustrated in FIG. 4, the drive signal COMB has a signal waveform in which a trapezoidal waveform Bdp1 arranged in the period t1 and a trapezoidal waveform Bdp2 arranged in the period t2 are continuous to each other. Further, the trapezoidal waveform Bdp1 is a signal waveform for not discharging the ink from the discharge section 600 when supplied to the piezoelectric element 60 included in the discharge section 600, and the trapezoidal waveform Bdp2 is a signal waveform for discharging a small amount of ink from the discharge section 600 when supplied to the piezoelectric element 60 included in the discharge section 600. Here, the trapezoidal waveform Bdp1 is a signal waveform for preventing an increase in ink viscosity by vibrating the ink in a vicinity of a nozzle opening portion included in the discharge section 600 to such an extent that the ink is not discharged. In the following description, when the trapezoidal waveform Bdp1 is supplied to the piezoelectric element 60 included in the discharge section 600, an operation of vibrating the ink in the vicinity of the nozzle opening portion may be referred to as micro-vibration.

Here, as illustrated in FIG. 4, the voltage values at the start timing and end timing of each of the trapezoidal waveforms Adp1, Adp2, Bdp1, and Bdp2 are all common to a voltage Vc. In other words, each of the trapezoidal waveforms Adp1, Adp2, Bdp1, and Bdp2 starts at the voltage Vc and ends at the voltage Vc. Then, a cycle tp including the period t1 and the period t2 corresponds to a printing cycle for forming new dots on the medium P.

Although FIG. 4 illustrates a case where the trapezoidal waveform Adp1 and the trapezoidal waveform Bdp2 have the same signal waveform, the trapezoidal waveform Adp1 and the trapezoidal waveform Bdp2 may have different signal waveforms. In addition, it is described that a small amount of ink is discharged from the common discharge section 600 when the trapezoidal waveform Adp1 is supplied to the piezoelectric element 60 included in the discharge section 600 and when the trapezoidal waveform Bdp2 is supplied to the piezoelectric element 60 included in the discharge section 600, but the present disclosure is not limited thereto. In other words, the signal waveforms of the drive signals COMA and COMB are not limited to the signal waveforms illustrated in FIG. 4, and combinations of various signal waveforms may be used depending on the nature of the ink discharged from the discharge section 600, the material of the medium P on which the discharged ink lands, and the like.

Further, in FIG. 4, a case where the timing at which the trapezoidal waveform Adp1 and the trapezoidal waveform Adp2 included in the drive signal COMA are switched, and the timing at which the trapezoidal waveform Bdp1 and the trapezoidal waveform Bdp2 included in the drive signal COMB are switched are defined by one change signal CH is exemplified. However, the change signal CH that defines the timing at which the trapezoidal waveform Adp1 and the trapezoidal waveform Adp2 included in the drive signal COMA are switched, and the change signal CH that defines the timing at which the trapezoidal waveform Bdp1 and the trapezoidal waveform Bdp2 included in the drive signal COMB are switched, may be different signals.

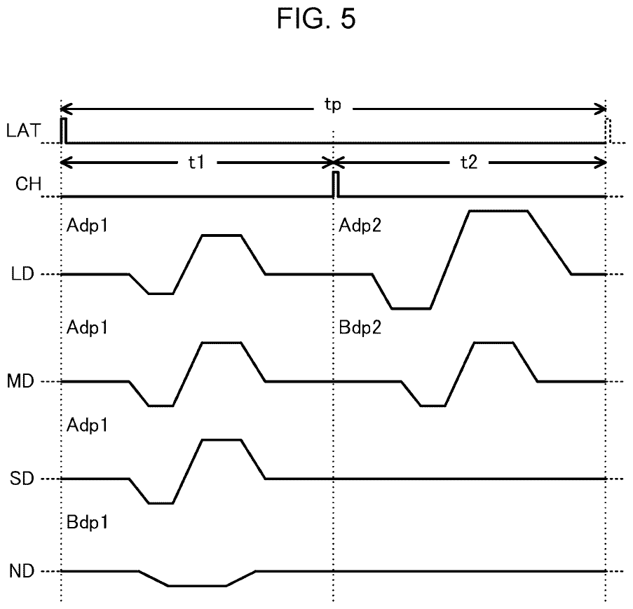

FIG. 5 is a diagram illustrating an example of the signal waveform of the drive voltage VOUT when the size of the dots formed on the medium P is any of a large dot LD, a medium dot MD, a small dot SD, and non-recording ND.

As illustrated in FIG. 5, the drive voltage VOUT when the large dot LD is formed on the medium P is a signal waveform in which the trapezoidal waveform Adp1 arranged in the period t1 in the cycle tp and the trapezoidal waveform Adp2 arranged in the period t2 in the cycle tp are continuous to each other. When the drive voltage VOUT is supplied to the piezoelectric element 60 included in the discharge section 600, a small amount of ink and a medium amount of ink are discharged from the corresponding discharge section 600. Therefore, each ink lands on the medium P and coalesces to form the large dot LD on the medium P in the cycle tp.

The drive voltage VOUT when the medium dot MD is formed on the medium P is a signal waveform in which the trapezoidal waveform Adp1 arranged in the period t1 in the cycle tp and the trapezoidal waveform Bdp2 arranged in the period t2 in the cycle tp are continuous to each other. When the drive voltage VOUT is supplied to the piezoelectric element 60 included in the discharge section 600, a small amount of ink is discharged two times from the corresponding discharge section 600. Therefore, each ink lands on the medium P and coalesces to form the medium dot MD on the medium P in the cycle tp.

The drive voltage VOUT when the small dot SD is formed on the medium P is a signal waveform in which the trapezoidal waveform Adp1 arranged in the period t1 in the cycle tp and a constant signal waveform arranged in the period t2 in the cycle tp at the voltage Vc are continuous to each other. When the drive voltage VOUT is supplied to the piezoelectric element 60 included in the discharge section 600, a small amount of ink is discharged once from the corresponding discharge section 600. Therefore, the ink lands on the medium P to form the small dot SD on the medium P in the cycle tp.

The drive voltage VOUT that corresponds to the non-recording ND that does not form dots on the medium P is a signal waveform in which the trapezoidal waveform Bdp1 arranged in the period t1 in the cycle tp and a constant signal waveform arranged in the period t2 in the cycle tp at the voltage Vc are continuous to each other. When the drive voltage VOUT is supplied to the piezoelectric element 60 included in the discharge section 600, the ink in the vicinity of the nozzle opening portion of the corresponding discharge section 600 micro-vibrates only, and no ink is discharged from the discharge section 600. Therefore, dots are not formed on the medium P in the cycle tp.

Here, in the constant signal waveform at the voltage Vc in the drive voltage VOUT, when none of the trapezoidal waveforms Adp1, Adp2, Bdp1, and Bdp2 is selected as the drive voltage VOUT, the voltage Vc immediately before the trapezoidal waveforms Adp1, Adp2, Bdp1, and Bdp2 corresponds to the voltage value held by the capacitive component of the piezoelectric element 60 included in the discharge section 600. In other words, when none of the trapezoidal waveforms Adp1, Adp2, Bdp1, and Bdp2 is selected as the drive voltage VOUT, the voltage Vc supplied immediately before is supplied to the piezoelectric element 60 included in the discharge section 600 as the drive voltage VOUT.

Here, as illustrated in FIG. 5, the drive signal selection circuit 200 selects or deselects the trapezoidal waveforms Adp1 and Adp2 included in the drive signal COMA and the trapezoidal waveforms Bdp1 and Bdp2 included in the drive signal COMB to generate the drive voltage VOUT individually corresponding to each of the plurality of discharge sections 600 and output the drive voltage VOUT to the piezoelectric element 60 included in the corresponding discharge section 600.

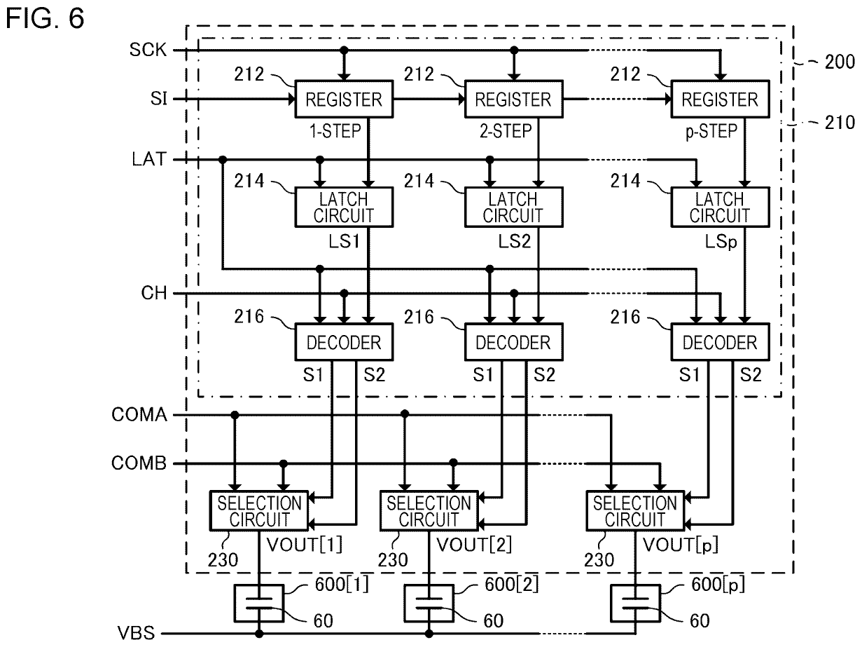

FIG. 6 is a diagram illustrating a functional configuration of the drive signal selection circuit 200. As illustrated in FIG. 6, the drive signal selection circuit 200 includes a selection control circuit 210 and a plurality of selection circuits 230. Further, in FIG. 6, the discharge sections 600[1] to 600[p] to which the drive voltages VOUT[1] to VOUT[p] output from the drive signal selection circuit 200 are supplied are collectively illustrated.

The print data signal SI, the clock signal SCK, the latch signal LAT, and the change signal CH are input to the selection control circuit 210. In the selection control circuit 210, a set of a register 212, a latch circuit 214, and a decoder 216 is provided corresponding to each of the discharge sections 600[1] to 600[p]. That is, the selection control circuit 210 includes at least the same number of sets of the registers 212, the latch circuits 214, and the decoders 216 as the discharge sections 600[1] to 600[p].

The print data signal SI is a signal synchronized with the clock signal SCK, which is a signal having a total of 2p bits serially including 2-bit print data [SIH, SIL] for selecting one of the large dot LD, the medium dot MD, the small dot SD, and the non-recording ND with respect to each of the discharge sections 600[1] to 600[p]. The print data signal SI is held in the register 212 for each print data [SIH, SIL] included in the print data signal SI in correspondence with the discharge sections 600[1] to 600[p].

Specifically, in the selection control circuit 210, the registers 212 are vertically coupled to each other to constitute a p-step shift register. Then, the print data [SIH, SIL] serially input as the print data signal SI is sequentially transferred to the register 212 in the subsequent step according to the clock signal SCK. Then, when the supply of the clock signal SCK is stopped, the print data [SIH, SIL] corresponding to each of the discharge sections 600[1] to 600[p] is held in the register 212 corresponding to each of the discharge sections 600[1] to 600[p]. In the following description, in order to distinguish the p registers 212 that constitute the shift register, the registers 212 may be referred to as 1-step, 2-step, . . . , p-step from the upstream to the downstream where the print data signal SI propagates.

Each of the p latch circuits 214 is provided corresponding to the p registers 212. Each of the latch circuits 214 latches the print data [SIH, SIL] held in each of the p registers 212 all at once at the rise of the latch signal LAT, and outputs the print data [SIH, SIL] to the corresponding decoder 216.

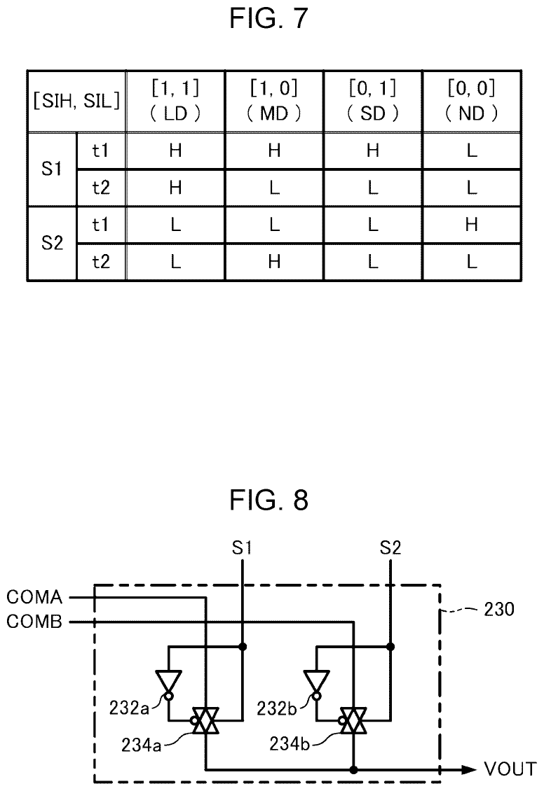

FIG. 7 is a table illustrating an example of the decoding contents in the decoder 216. The decoder 216 generates and outputs selection signals S1 and S2 by decoding the print data [SIH, SIL] latched by the latch circuit 214 with the contents illustrated in FIG. 7. For example, when the input print data [SIH, SIL] is [1, 0], the decoder 216 outputs logic levels of the selection signal S1 to the selection circuit 230 as the H and L levels in the periods t1 and t2, and outputs logic levels of the selection signal S2 to the selection circuit 230 as L and H levels in the periods t1 and t2.

The selection circuit 230 is provided corresponding to each of the p discharge sections 600. In other words, the drive signal selection circuit 200 has p selection circuits 230 that are at least the same in number as the p discharge sections 600. FIG. 8 is a diagram illustrating a configuration of the selection circuit 230 that corresponds to one discharge section 600. As illustrated in FIG. 8, the selection circuit 230 has inverters 232a and 232b, which are NOT circuits, and transfer gates 234a and 234b.

While the selection signal S1 is input to a positive control end which is not marked with a circle at the transfer gate 234a, the selection signal S1 is logically inverted by the inverter 232a and is input to a negative control end marked with a circle at the transfer gate 234a. In addition, the drive signal COMA is supplied to an input end of the transfer gate 234a. While the selection signal S2 is input to the positive control end which is not marked with a circle at the transfer gate 234b, the selection signal S2 is logically inverted by the inverter 232b and is input to the negative control end marked with a circle at the transfer gate 234b. In addition, the drive signal COMB is supplied to an input end of the transfer gate 234b. Then, the output end of the transfer gate 234a and the output end of the transfer gate 234b are commonly coupled. A signal at the coupling end to which the output end of the transfer gate 234a and the output end of the transfer gate 234b are commonly coupled is output as the drive voltage VOUT.

Specifically, the input end and the output end of the transfer gate 234a are made conductive when the selection signal S1 is the H level, and the input end and the output end of the transfer gate 234a are made non-conductive when the selection signal S1 is the L level. In addition, the input end and the output end of the transfer gate 234b are made conductive when the selection signal S2 is the H level, and the input end and the output end of the transfer gate 234b are made non-conductive when the selection signal S2 is the L level. That is, the selection circuit 230 switches the conduction state between the input ends and the output ends of the transfer gates 234a and 234b based on the selection signals S1 and S2, to select or deselect the signal waveforms of the drive signals COMA and COMB supplied to the input ends of the transfer gates 234a and 234b, and output the drive voltage VOUT to the coupling end at which the output end of the transfer gate 234a and the output end of the transfer gate 234b are commonly coupled.

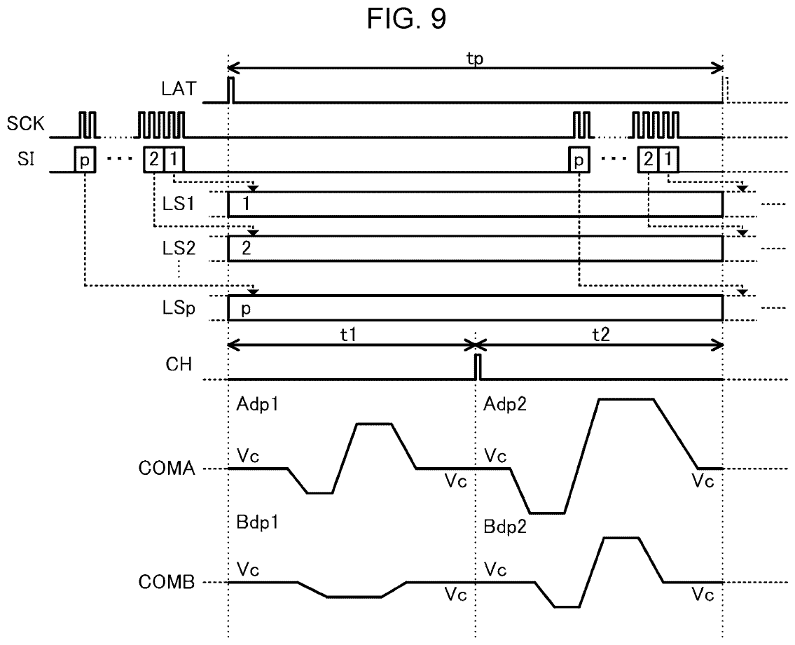

The operation of the drive signal selection circuit 200 will be described with reference to FIG. 9. FIG. 9 is a diagram for describing the operation of the drive signal selection circuit 200. The print data [SIH, SIL] included in the print data signal SI is serially input in synchronization with the clock signal SCK. Then, the print data [SIH, SIL] is sequentially transferred by the register 212 that configures the shift register corresponding to the p discharge sections 600 in synchronization with the clock signal SCK. After that, when the supply of the clock signal SCK is stopped, the print data [SIH, SIL] are held in each of the registers 212 corresponding to each of the p discharge sections 600. The print data [SIH, SIL] included in the print data signal SI is input in the order corresponding to the discharge sections 600 at the p-step, . . . , 2-step, and 1-step of the register 212 that configures the shift register.

When the latch signal LAT rises, each of the latch circuits 214 latches the print data [SIH, SIL] held in the register 212 all at once. In addition, in FIG. 9, LS1, LS2, . . . , and LSp indicate the print data [SIH, SIL] latched by the latch circuits 214 that correspond to the registers 212 at the 1-step, 2-step, . . . , and p-step.

The decoder 216 outputs the logic levels of the selection signals S1 and S2 in each of the periods t1 and t2 with the contents illustrated in FIG. 7, according to the size of the dot defined by the latched print data [SIH, SIL].

Specifically, when the input print data [SIH, SIL] is [1, 1], the decoder 216 sets the logic level of the selection signal S1 to the H and H levels in the periods t1 and t2, and sets the logic level of the selection signal S2 to the L and L levels in the periods t1 and t2. In this case, the selection circuit 230 selects the trapezoidal waveform Adp1 in the period t1 and selects the trapezoidal waveform Adp2 in the period t2. As a result, at the output end of the selection circuit 230, the drive voltage VOUT that corresponds to the large dot LD illustrated in FIG. 5 is generated.

In addition, when the input print data [SIH, SIL] is [1, 0], the decoder 216 sets the logic level of the selection signal S1 to the H and L levels in the periods t1 and t2, and sets the logic level of the selection signal S2 to the L and H levels in the periods t1 and t2. In this case, the selection circuit 230 selects the trapezoidal waveform Adp1 in the period t1 and selects the trapezoidal waveform Bdp2 in the period t2. As a result, at the output end of the selection circuit 230, the drive voltage VOUT that corresponds to the medium dot MD illustrated in FIG. 5 is generated.

In addition, when the input print data [SIH, SIL] is [0, 1], the decoder 216 sets the logic level of the selection signal S1 to the H and L levels in the periods t1 and t2, and sets the logic level of the selection signal S2 to the L and L levels in the periods t1 and t2. In this case, the selection circuit 230 selects the trapezoidal waveform Adp1 in the period t1 and selects none of the trapezoidal waveforms Adp2 and Bdp2 in the period t2. As a result, at the output end of the selection circuit 230, the drive voltage VOUT that corresponds to the small dot SD shown in FIG. 5 is generated.

In addition, when the input print data [SIH, SIL] is [0, 0], the decoder 216 sets the logic level of the selection signal S1 to the L and L levels in the periods t1 and t2, and sets the logic level of the selection signal S2 to the H and L levels in the periods t1 and t2. In this case, the selection circuit 230 selects the trapezoidal waveform Bdp1 in the period t1 and selects none of the trapezoidal waveforms Adp2 and Bdp2 in the period t2. As a result, at the output end of the selection circuit 230, the drive voltage VOUT that corresponds to the non-recording ND illustrated in FIG. 5 is generated.

As described above, the drive signal selection circuit 200 generates and outputs the drive voltages VOUT[1] to VOUT[p] by selecting the signal waveforms of the drive signal COMA and the drive signal COMB based on the print data signal SI, the clock signal SCK, the latch signal LAT, and the change signal CH.

### 1-5. Configuration of Drive Signal Correction Circuit

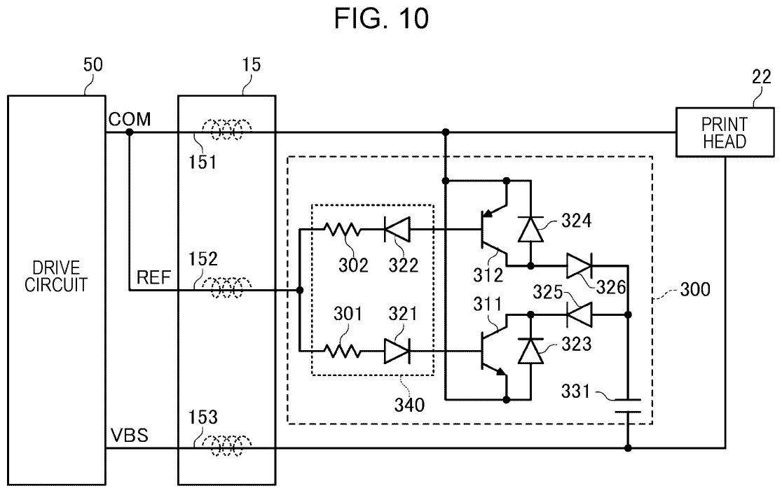

Next, the configuration and operation of the drive signal correction circuit 300 will be described. FIG. 10 is a diagram showing a configuration of the drive signal correction circuit 300. As shown in FIG. 10, the drive signal correction circuit 300 includes a first resistor 301, a second resistor 302, a first transistor 311, a second transistor 312, a first diode 321, a second diode 322, a third diode 323, a fourth diode 324, a fifth diode 325, a sixth diode 326, and a capacitor 331.

One end of the first resistor 301 and one end of the second resistor 302 are electrically coupled to the reference waveform signal supply line 152 of the cable 15. The first resistor 301 has the reference waveform signal REF supplied to one end and the other end coupled to the anode of the first diode 321. The second resistor 302 has the reference waveform signal REF supplied to one end and the other end coupled to the cathode of the second diode 322.

The first transistor 311 is an NPN-type bipolar transistor, and the second transistor 312 is a PNP-type bipolar transistor. The emitter of the first transistor 311 and the emitter of the second transistor 312 are electrically coupled to the drive signal supply line 151 of the cable 15 and the drive signal selection circuit 200 of the print head 22. The base of the first transistor 311 is coupled to the cathode of the first diode 321, and the drive signal COM is supplied to the emitter. The base of the second transistor 312 is coupled to the anode of the second diode 322, and the drive signal COM is supplied to the emitter.

The anode of the third diode 323 is coupled to the emitter of the first transistor 311, and the cathode is coupled to the collector of the first transistor 311. The anode of the fourth diode 324 is coupled to the collector of the second transistor 312, and the cathode is coupled to the emitter of the second transistor 312.

The anode of the fifth diode 325 is coupled to one end of the capacitor 331, and the cathode is coupled to a collector of the first transistor 311. The anode of the sixth diode 326 is coupled to the collector of the second transistor 312, and the cathode is coupled to one end of the capacitor 331. The other end of the capacitor 331 is electrically coupled to the reference voltage signal supply line 153 of the cable 15, and the reference voltage signal VBS is supplied. Since a constant potential lower than the lowest potential of the drive signal COM may be supplied to the other end of the capacitor 331, the ground potential may be supplied instead of the reference voltage signal VBS.

The third diode 323, the fourth diode 324, the fifth diode 325, and the sixth diode 326 are diodes for preventing reverse flow.

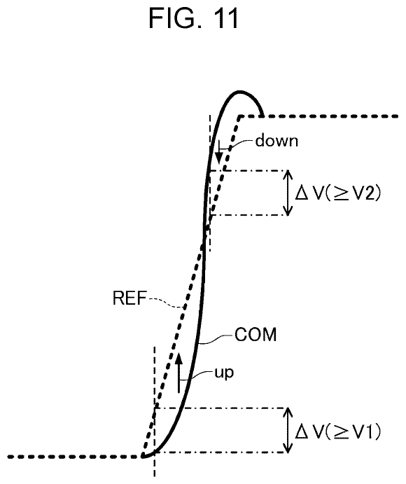

FIG. 11 is a diagram showing a part of the waveforms of the drive signal COM via the drive signal supply line 151 and the reference waveform signal REF via the reference waveform signal supply line 152. As described above, the waveform of the drive signal COM via the drive signal supply line 151 is distorted by the inductance component of the cable 15. Specifically, as shown in FIG. 11, in a period in which the voltage of the drive signal COM rises, a period in which the voltage of the drive signal COM is lower than the voltage of the reference waveform signal REF or the period in which the voltage of the drive signal COM is higher than the voltage of the reference waveform signal REF occurs.

In the drive signal correction circuit 300 shown in FIG. 10, in a period in which the voltage of the drive signal COM is lower than the voltage of the reference waveform signal REF, when the potential difference ΔV between the reference waveform signal REF and the drive signal COM is equal to or greater than a first voltage V1, a current flows from the base to the emitter of the first transistor 311, and the first transistor 311 is conductive between the collector and the emitter. Therefore, the electric charges accumulated in the capacitor 331 flow to the print head 22 via the first transistor 311 so that the voltage of the drive signal COM supplied to the print head 22 rises. That is, the drive signal correction circuit 300 steps up the drive signal COM and supplies the boosted drive signal COM to the drive signal selection circuit 200 of the print head 22 when the voltage of the drive signal COM is lower than the voltage of the reference waveform signal REF by the first voltage V1 or more.

In addition, in the drive signal correction circuit 300 shown in FIG. 10, in a period in which the voltage of the drive signal COM is higher than the voltage of the reference waveform signal REF, when the potential difference AV between the drive signal COM and the reference waveform signal REF is equal to or higher than a second voltage V2, a current flows from the emitter to the base of the second transistor 312, and the second transistor 312 is conductive between the emitter and the collector. Therefore, a current flows from the drive circuit 50 to one end of the capacitor 331 via the drive signal supply line 151 and the second transistor 312 so that the voltage of the drive signal COM supplied to the print head 22 is stepped down and electric charges are accumulated in the capacitor 331. That is, the drive signal correction circuit 300 steps down the drive signal COM and supplies the stepped-down drive signal COM to the drive signal selection circuit 200 of the print head 22 when the voltage of the drive signal COM is higher than the voltage of the reference waveform signal REF by the second voltage V2 or more.

In the drive signal correction circuit 300 shown in FIG. 10, the first voltage V1 is a sum of a forward voltage of PN junction between the base and the emitter of the first transistor 311, a forward voltage of the first diode 321, and a voltage across the first resistor 301. For example, the forward voltage of the PN junction between the base and the emitter of the first transistor 311 and the forward voltage of the first diode 321 are approximately 0.7 V, respectively, and the voltage across the first resistor 301 is approximately 0.1 V. In this case, the first voltage V1 is approximately 1.5 V.

The second voltage V2 is a sum of a forward voltage of the PN junction between the emitter and the base of the second transistor 312, a forward voltage of the second diode 322, and a voltage across the second resistor 302. For example, the forward voltage of the PN junction between the emitter and the base of the second transistor 312 and the forward voltage of the second diode 322 are approximately 0.7 V, respectively, and the voltage across the second resistor 302 is approximately 0.1 V. In this case, the second voltage V2 is approximately 1.5 V.

The first resistor 301, the second resistor 302, the first diode 321, and the second diode 322 function as an adjustment circuit 340 that adjusts the first voltage V1 and the second voltage V2. In other words, the adjustment circuit 340 adjusts the first voltage V1 based on the voltage across the first resistor 301 generated by the current flowing through the first resistor 301. Further, the adjustment circuit 340 adjusts the first voltage V1 based on the forward voltage of the first diode 321. In addition, the adjustment circuit 340 adjusts the second voltage V2 based on the voltage across the second resistor 302 generated by the current flowing through the second resistor 302. Further, the adjustment circuit 340 adjusts the second voltage V2 based on the forward voltage of the second diode 322. For example, the higher the resistance value of the first resistor 301, the higher the first voltage V1, and the first voltage V1 becomes higher when the diode is added in series to the first diode 321. As described above, the first voltage V1 and the second voltage V2 can be set to appropriate voltages by the adjustment circuit 340 so that the distortion of the waveform of the drive signal COM is reduced.

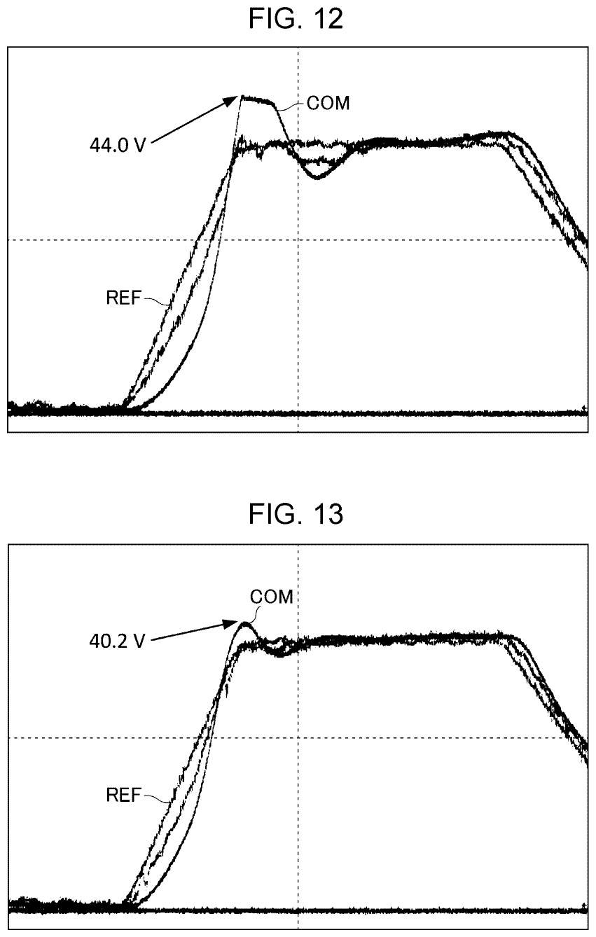

FIG. 12 is a diagram showing a measurement example of a drive signal and a reference waveform signal in a comparative example. Although FIG. 12 is a diagram showing a part of the waveforms of the drive signal COM via the drive signal supply line 151 and the reference waveform signal REF via the reference waveform signal supply line 152 as in FIG. 11, since the comparative example does not include the drive signal correction circuit 300, the drive signal COM has a shape that is largely distorted as compared with the reference waveform signal REF.

FIG. 13 is a diagram showing a measurement example of a drive signal and a reference waveform signal in the present embodiment. Although FIG. 13 is a diagram showing a part of the waveforms of the drive signal COM via the drive signal supply line 151 and the reference waveform signal REF via the reference waveform signal supply line 152 as in FIG. 11, since the present example includes the drive signal correction circuit 300, the distortion of the drive signal COM with respect to the reference waveform signal REF is smaller than that of the comparative example.

### 1-6. Action and Effect

As described above, in the liquid discharge apparatus 1 of the first embodiment, the change in the current is suppressed by the inductance component of the drive signal supply line 151 for supplying the drive signal COM from the control unit 10 to the head unit 20. Therefore, undershoot in which the voltage of the drive signal COM is lower than the voltage of the reference waveform signal REF or overshoot in which the voltage of the drive signal COM is higher than the voltage of the reference waveform signal REF may occur. On the other hand, the drive signal correction circuit 300 steps up the drive signal COM when the voltage of the drive signal COM is lower than the voltage of the reference waveform signal REF by the first voltage V1 or more. Therefore, the undershoot is reduced. The drive signal correction circuit 300 steps down the drive signal COM when the voltage of the drive signal COM is higher than the voltage of the reference waveform signal REF by the second voltage V2 or more. Therefore, the overshoot is reduced. Therefore, according to the liquid discharge apparatus 1 of the first embodiment, the distortion of the waveform of the drive signal COM is reduced, and the discharge accuracy of the ink by each discharge section 600 of the print head 22 is improved. In particular, as the number of discharge sections 600 to which the drive signal COM is applied increases and the amount of a current flowing through the drive signal supply line 151 increases, the waveform distortion of the drive signal COM is likely to increase. Therefore, the reduction effect of waveform distortion of the drive signal COM by the drive signal correction circuit 300 is significant.

Further, according to the liquid discharge apparatus 1 of the first embodiment, the drive signal correction circuit 300 corrects the waveform of the drive signal COM at the time of undershoot by using the energy regenerated to the capacitor 331 when the drive signal COM overshoots. Thus, the power consumption and the amount of heat generated are reduced.

### 2. Second Embodiment

Hereinafter, components of a second embodiment similar to the first embodiment will be given the same reference numerals, the description overlapping with the first embodiment will be omitted or simplified, and contents different from the first embodiment will be mainly described.

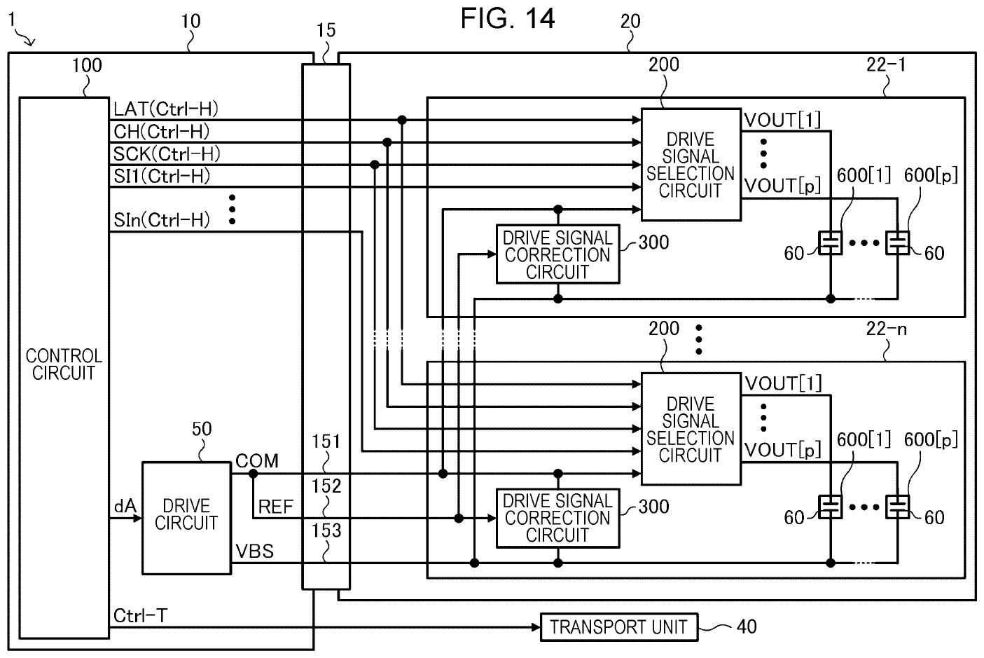

FIG. 14 is a diagram showing a functional configuration of the liquid discharge apparatus 1 of the second embodiment. As shown in FIG. 2, in the liquid discharge apparatus 1 of the first embodiment, the drive signal correction circuit 300 is provided outside the print heads 22-1 to 22-n in the head unit 20. However, as shown in FIG. 14, in the liquid discharge apparatus 1 of the second embodiment, the drive signal correction circuit 300 is provided inside each of the print heads 22-1 to 22-n.

That is, in the liquid discharge apparatus 1 of the second embodiment, each print head 22 includes the discharge sections 600[1] to 600[p] that discharge ink when the drive signal COM is applied, the drive signal selection circuit 200 that controls the application of the drive signal COM to the discharge sections 600[1] to 600[p], and the drive signal correction circuit 300.

When the voltage of the drive signal COM is lower than the voltage of the reference waveform signal REF by the first voltage V1 or more, the drive signal correction circuit 300 steps up the drive signal COM and supplies the drive signal COM to the drive signal selection circuit 200. Further, the drive signal correction circuit 300 steps down the drive signal COM and supplies the drive signal COM to the drive signal selection circuit 200 when the voltage of the drive signal COM is higher than the voltage of the reference waveform signal REF by the second voltage V2 or more.

The drive signal COM is supplied to the drive signal correction circuit 300 via the drive signal supply line 151 outside the print head 22. The reference waveform signal REF is supplied to the drive signal correction circuit 300 via the reference waveform signal supply line 152 outside the print head 22. Specifically, the drive signal COM before being supplied from the drive circuit 50 to the drive signal supply line 151 is supplied to the drive signal correction circuit 300 via the reference waveform signal supply line 152 as the reference waveform signal REF.

Since the specific configuration of the drive signal correction circuit 300 is the same as that in FIG. 10, the illustration and description thereof will be omitted. In addition, since the specific operation of the drive signal correction circuit 300 is the same as that of the first embodiment, the description thereof will be omitted.

Other configurations and functions of the liquid discharge apparatus 1 of the second embodiment are the same as those of the first embodiment, and thus the description thereof will be omitted.

According to the liquid discharge apparatus 1 of the second embodiment described above, effects similar to the liquid discharge apparatus 1 of the first embodiment can be obtained.

The present disclosure is not limited to the present embodiment, and various modifications can be made within the scope of the spirit of the present disclosure.

The present disclosure includes substantially the same configurations (for example, configurations having the same functions, methods, and results, or configurations having the same objects and effects) as the configurations described in the present embodiment. Further, the present disclosure includes configurations in which non-essential parts of the configuration described in the present embodiment are replaced. In addition, the present disclosure includes configurations that achieve the same operational effects or configurations that can achieve the same objects as those of the configurations described in the present embodiment. Further, the present disclosure includes configurations in which a known technology is added to the configurations described in the present embodiment.

The embodiment and the modification example described above are merely examples, and the present disclosure is not limited thereto. For example, each embodiment and each modification example can be combined as appropriate.

The following contents are derived from the above-described embodiments and modification examples.

A liquid discharge apparatus according to one aspect includes a head unit, a carriage on which the head unit is mounted, a control unit including a drive circuit that generates a drive signal, and a drive signal supply line that supplies the drive signal from the control unit to the head unit, in which the head unit includes a print head provided with a discharge section that discharges liquid when the drive signal is applied, and a drive controller that controls the application of the drive signal to the discharge section, and a drive signal correction circuit electrically coupled to the drive signal supply line, and the drive signal correction circuit steps up the drive signal and supplies the drive signal to the drive controller when a voltage of the drive signal supplied from the control unit via the drive signal supply line is lower than a voltage of a reference waveform signal by a first voltage or more.

In this liquid discharge apparatus, since the change in a current is suppressed by the inductance component of the drive signal supply line that supplies the drive signal from the control unit to the head unit, undershoot in which the voltage of the drive signal is lower than the voltage of the reference waveform signal may occur. On the other hand, according to this liquid discharge apparatus, the drive signal correction circuit steps up the drive signal when the voltage of the drive signal is lower than the voltage of the reference waveform signal by a first voltage or more. Therefore, the undershoot is reduced, and the distortion of the waveform of the drive signal can be reduced.

The liquid discharge apparatus according to the aspect may include a reference waveform signal supply line that supplies the drive signal before being supplied to the drive signal supply line from the control unit to the drive signal correction circuit as the reference waveform signal.

According to this liquid discharge apparatus, the drive signal correction circuit can accurately reduce the distortion of the waveform of the drive signal with reference to the voltage of the reference waveform signal based on the drive signal having no distortion of the waveform before being supplied to the drive signal supply line.

In the liquid discharge apparatus according to the aspect, the drive signal correction circuit may include a first resistor, a second resistor, a first transistor, a second transistor, a first diode, a second diode, a third diode, a fourth diode, a fifth diode, a sixth diode, and a capacitor, the first resistor may have one end supplied with the reference waveform signal and another end coupled to an anode of the first diode, the second resistor may have one end supplied with the reference waveform signal and another end coupled to a cathode of the second diode, the first transistor may be an NPN bipolar transistor, a base of which is coupled to a cathode of the first diode and an emitter of which is supplied with the drive signal, the second transistor may be a PNP bipolar transistor, a base of which is coupled to an anode of the second diode and an emitter of which is supplied with the drive signal, the third diode may have an anode coupled to the emitter of the first transistor and a cathode coupled to a collector of the first transistor, the fourth diode may have an anode coupled to a collector of the second transistor and a cathode coupled to the emitter of the second transistor, the fifth diode may have an anode coupled to one end of the capacitor and a cathode coupled to the collector of the first transistor, and the sixth diode may have an anode coupled to the collector of the second transistor and a cathode coupled to the one end of the capacitor.

In the liquid discharge apparatus according to the aspect, the drive signal correction circuit may include an adjustment circuit that adjusts the first voltage.

According to this liquid discharge apparatus, the first voltage can be set to an appropriate voltage so that the distortion of the waveform of the drive signal is reduced.

In the liquid discharge apparatus according to the aspect, the adjustment circuit may include a first resistor, and may adjust the first voltage based on a voltage across the first resistor generated by a current flowing through the first resistor.

In the liquid discharge apparatus according to the aspect, the adjustment circuit may include a first diode, and may adjust the first voltage based on a forward voltage of the first diode.

In the liquid discharge apparatus according to the aspect, the drive signal correction circuit may step down the drive signal and supply the drive signal to the drive controller when the voltage of the drive signal supplied from the control unit via the drive signal supply line is higher than the voltage of the reference waveform signal by a second voltage or more.

In this liquid discharge apparatus, since the change in the current is suppressed by the inductance component of the drive signal supply line that supplies the drive signal from the control unit to the head unit, overshoot in which the voltage of the drive signal is higher than the voltage of the reference waveform signal may occur. On the other hand, according to this liquid discharge apparatus, the drive signal correction circuit steps down the drive signal when the voltage of the drive signal is higher than the voltage of the reference waveform signal by the second voltage or more. Therefore, the overshoot is reduced, and the distortion of the waveform of the drive signal can be reduced.

A print head according to one aspect includes a discharge section that discharges liquid when a drive signal is applied, a drive controller that controls the application of the drive signal to the discharge section, and a drive signal correction circuit, in which the drive signal is supplied to the drive signal correction circuit via a drive signal supply line outside the print head, and the drive signal correction circuit steps up the drive signal and supplies the drive signal to the drive controller when a voltage of the drive signal is lower than a voltage of a reference waveform signal by a first voltage or more.

In this print head, the change in the current is suppressed by the inductance component of the outside drive signal supply line that supplies the drive signal. Therefore, undershoot in which the voltage of the drive signal supplied from the outside is lower than the voltage of the reference waveform signal may occur. On the other hand, according to this print head, the drive signal correction circuit steps up the drive signal when the voltage of the drive signal is lower than the voltage of the reference waveform signal by a first voltage or more. Therefore, the undershoot is reduced, and the distortion of the waveform of the drive signal can be reduced.

In the print head according to the aspect, the drive signal supplied before being supplied to the drive signal supply line may be supplied to the drive signal correction circuit via a reference waveform signal supply line outside the print head as the reference waveform signal.

According to this print head, the drive signal correction circuit can accurately reduce the distortion of the waveform of the drive signal with reference to the voltage of the reference waveform signal based on the drive signal having no distortion of the waveform before being supplied to the drive signal supply line.

In the print head according to the aspect, the drive signal correction circuit may include a first resistor, a second resistor, a first transistor, a second transistor, a first diode, a second diode, a third diode, a fourth diode, a fifth diode, a sixth diode, and a capacitor, the first resistor may have one end supplied with the reference waveform signal and another end coupled to an anode of the first diode, the second resistor may have one end supplied with the reference waveform signal and another end coupled to a cathode of the second diode, the first transistor may be an NPN bipolar transistor, a base of which is coupled to a cathode of the first diode and an emitter of which is supplied with the drive signal, the second transistor may be a PNP bipolar transistor, a base of which is coupled to an anode of the second diode and an emitter of which is supplied with the drive signal, the third diode may have an anode coupled to the emitter of the first transistor and a cathode coupled to a collector of the first transistor, the fourth diode may have an anode coupled to a collector of the second transistor and a cathode coupled to the emitter of the second transistor, the fifth diode may have an anode coupled to one end of the capacitor and a cathode coupled to the collector of the first transistor, and the sixth diode may have an anode coupled to the collector of the second transistor and a cathode coupled to the one end of the capacitor.

In the print head according to the aspect, the drive signal correction circuit may include an adjustment circuit that adjusts the first voltage.

According to this print head, the first voltage can be set to an appropriate voltage so that the distortion of the waveform of the drive signal is reduced.

In the print head according to the aspect, the adjustment circuit may include a first resistor, and may adjust the first voltage based on a potential difference across the first resistor generated by a current flowing through the first resistor.

In the print head according to the aspect, the adjustment circuit may include a first diode, and may adjust the first voltage based on a forward voltage of the first diode.

In the print head according to the aspect, the drive signal correction circuit may step down the drive signal and supply the drive signal to the drive controller when the voltage of the drive signal is higher than the voltage of the reference waveform signal by a second voltage or more.

In this print head, the change in the current is suppressed by the inductance component of the outside drive signal supply line that supplies the drive signal. Therefore, overshoot in which the voltage of the drive signal supplied from the outside is higher than the voltage of the reference waveform signal may occur. On the other hand, according to the print head, the drive signal correction circuit steps down the drive signal when the voltage of the drive signal is higher than the voltage of the reference waveform signal by the second voltage or more. Therefore, the overshoot is reduced, and the distortion of the waveform of the drive signal can be reduced.

What is claimed is:

1. A liquid discharge apparatus comprising:
a head unit;
a carriage on which the head unit is mounted;
a control unit including a drive circuit that generates a drive signal; and
a drive signal supply line that supplies the drive signal from the control unit to the head unit, wherein
the head unit includes
a print head provided with a discharge section that discharges liquid when the drive signal is applied, and a drive controller that controls the application of the drive signal to the discharge section, and
a drive signal correction circuit electrically coupled to the drive signal supply line, and
the drive signal correction circuit steps up the drive signal and supplies the drive signal to the drive controller when a voltage of the drive signal supplied from the control unit via the drive signal supply line is lower than a voltage of a reference waveform signal by a first voltage or more.

2. The liquid discharge apparatus according to claim 1, further comprising:
a reference waveform signal supply line that supplies the drive signal before being supplied to the drive signal supply line from the control unit to the drive signal correction circuit as the reference waveform signal.

3. The liquid discharge apparatus according to claim 1, wherein
the drive signal correction circuit includes
a first resistor,
a second resistor,
a first transistor,
a second transistor,
a first diode,
a second diode,
a third diode,
a fourth diode,
a fifth diode,
a sixth diode, and
a capacitor,
the first resistor has one end supplied with the reference waveform signal and another end coupled to an anode of the first diode,
the second resistor has one end supplied with the reference waveform signal and another end coupled to a cathode of the second diode,
the first transistor is an NPN bipolar transistor, a base of which is coupled to a cathode of the first diode and an emitter of which is supplied with the drive signal,
the second transistor is a PNP bipolar transistor, a base of which is coupled to an anode of the second diode and an emitter of which is supplied with the drive signal,
the third diode has an anode coupled to the emitter of the first transistor and a cathode coupled to a collector of the first transistor,
the fourth diode has an anode coupled to a collector of the second transistor and a cathode coupled to the emitter of the second transistor,
the fifth diode has an anode coupled to one end of the capacitor and a cathode coupled to the collector of the first transistor, and
the sixth diode has an anode coupled to the collector of the second transistor and a cathode coupled to the one end of the capacitor.

4. The liquid discharge apparatus according to claim 1, wherein
the drive signal correction circuit includes an adjustment circuit that adjusts the first voltage.

5. The liquid discharge apparatus according to claim 4, wherein
the adjustment circuit includes a first resistor, and adjusts the first voltage based on a voltage across the first resistor generated by a current flowing through the first resistor.

6. The liquid discharge apparatus according to claim 4, wherein
the adjustment circuit includes a first diode, and adjusts the first voltage based on a forward voltage of the first diode.

7. The liquid discharge apparatus according to claim 1, wherein
the drive signal correction circuit steps down the drive signal and supplies the drive signal to the drive controller when the voltage of the drive signal supplied from the control unit via the drive signal supply line is higher than the voltage of the reference waveform signal by a second voltage or more.

8. A print head comprising:
a discharge section that discharges liquid when a drive signal is applied;
a drive controller that controls the application of the drive signal to the discharge section; and
a drive signal correction circuit, wherein
the drive signal is supplied to the drive signal correction circuit via a drive signal supply line outside the print head, and
the drive signal correction circuit steps up the drive signal and supplies the drive signal to the drive controller when a voltage of the drive signal is lower than a voltage of a reference waveform signal by a first voltage or more.

9. The print head according to claim 8, wherein
the drive signal before being supplied to the drive signal supply line is supplied to the drive signal correction circuit as the reference waveform signal via a reference waveform signal supply line outside the print head.

10. The print head according to claim 8, wherein
the drive signal correction circuit includes
a first resistor,
a second resistor,
a first transistor,
a second transistor,
a first diode,
a second diode,
a third diode,
a fourth diode,
a fifth diode,
a sixth diode, and
a capacitor,
the first resistor has one end supplied with the reference waveform signal and another end coupled to an anode of the first diode,
the second resistor has one end supplied with the reference waveform signal and another end coupled to a cathode of the second diode,
the first transistor is an NPN bipolar transistor, a base of which is coupled to a cathode of the first diode and an emitter of which is supplied with the drive signal,
the second transistor is a PNP bipolar transistor, a base of which is coupled to an anode of the second diode and an emitter of which is supplied with the drive signal,
the third diode has an anode coupled to the emitter of the first transistor and a cathode coupled to a collector of the first transistor,
the fourth diode has an anode coupled to a collector of the second transistor and a cathode coupled to the emitter of the second transistor,
the fifth diode has an anode coupled to one end of the capacitor and a cathode coupled to the collector of the first transistor, and
the sixth diode has an anode coupled to the collector of the second transistor and a cathode coupled to the one end of the capacitor.

11. The print head according to claim 8, wherein
the drive signal correction circuit includes an adjustment circuit that adjusts the first voltage.

12. The print head according to claim 11, wherein
the adjustment circuit includes a first resistor, and adjusts the first voltage based on a potential difference across the first resistor generated by a current flowing through the first resistor.

13. The print head according to claim 11, wherein
the adjustment circuit includes a first diode, and adjusts the first voltage based on a forward voltage of the first diode.

14. The print head according to claim 8, wherein
the drive signal correction circuit steps down the drive signal and supplies the drive signal to the drive controller when the voltage of the drive signal is higher than the voltage of the reference waveform signal by a second voltage or more.
